(19) United States
(12) Patent Application Publication
(10) Pub. No.: US 2005/0155032 A1
(43) Pub. Date: Jul. 14, 2005

(54) Dynamic load balancing

(76) Inventor: John L. Schantz, Plano, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/755,608

(22) Filed: Jan. 12, 2004

(51) Int. Cl. G06F 9/46

(52) U.S. Cl. 718/100; 718/105

(57) ABSTRACT

A method for redistributing workload among a plurality of processors in a computer system, whereby each processor of the plurality of processors is associated with a load value that indicates a level of workload assigned to the each processor is disclosed. The method includes determining an average utilization level for the plurality of processors. The method further includes incrementing in a first scenario, if a utilization level of one of the processors is above the average utilization level by more than a predefined threshold, the load value assigned to each of the plurality of processors, except processors whose utilization level is above the average utilization level by more than the predefined threshold and whose immediately preceding adjustment to its load value in a previous adjustment cycle was an increment.

### BACKGROUND OF THE INVENTION

Multiprocessor systems have long been employed to handle the need of processor-intensive applications. In a typical multiprocessor system, the application or instantiations thereof may execute independently on the processors. The work to be handled is distributed among the processors by a front-end system to allow the processors to share the workload. For example, applications that process SS7 messages in a telecommunication system are often deployed in a multiprocessor system so that incoming SS7 messages can be efficiently handled by a plurality of processors.

Since there are multiple processors independently executing in a multiprocessor system, there is a need to efficiently distribute the work among the processors so that the processors are efficiently utilized and the workload, as a whole, is efficiently processed. In the SS7 example, the SS7 messages to be processed are typically packaged into a plurality of bundles, each of which may be determined by the input buffer size or by the amount of data received in a given time period. The bundles that contain the SS7 messages are then distributed among the processors of the multi-process system by one or more SS7 front-end processors.

The distribution of the bundles among the processors may employ a scheme such as round-robin, which may be unweighted or weighted. In unweighted round-robin, the number of bundles received by each processor remains constant. In weighted round-robin, the number of bundles received by each processor may differ. Furthermore, the number of bundles may be adjusted periodically based on processor utilization.

FIG. 1 shows an example of a multi-processor system comprising CPU₀-CPU_{N} for handling bundles of SS7 messages distributed by a plurality of SS7 front-ends 102 and 104. In the example of FIG. 1, each of CPU₀-CPU_{N} is assigned to receive four bundles in a round-robin manner. Thus, SS7 messages are packaged into bundles 106A-106D destined for CPU₀, into bundles 108A-108D destined for CPU₁, and bundles 110A-110D destined for CPU_{N}. Bundles 106A-106D and bundle 108A are shown to be non-empty bundles, i.e., bundles containing with SS7 messages to be sent to their respective CPUs while the other bundles are shown to be empty bundles in the example of FIG. 1.

Periodically, the utilization levels of CPU₀-CPU_{N} is checked, and the number of bundles assigned to the processors is adjusted to avoid overloading any particular processor. There are many schemes for adjusting the values of the bundles sent to the processor.

In one example known to the inventor, the initial value of the bundles is fixed and can be changed only under the following conditions.

If a processor's utilization is 80% and this is 15% higher than the average processor utilization, then the number of bundles that this processor is allowed to receive is reduced by 1.

If this processor utilization drops below 70%, the number of bundles that this processor is allowed to receive is increased by 1.

If this processor utilization drops below 50%, the number of bundles for this processor is reset to the initial value.

If 50% or more of the processors are at 80% utilization or above, all bundle values are reset to the initial value.

FIG. 2 shows CPU₁ having a higher than normal load under the criteria above. Accordingly, the number of bundles received by CPU₁ will be decremented by 1 in the next turn. This is shown in FIG. 2 by the X symbol through bundle 108D.

Although the adjustment scheme discussed above addresses spikes in traffic, there are disadvantages. For example, the above scheme does not attempt to balance the processor load unless a large imbalance occurs. As can be seen, the action to remedy load imbalance to a processor is taken only if the processor's utilization is above 80%, and the imbalance is greater than 15%, for example. Furthermore, the above discussed scheme assumes that all messages require the same amount of processing, a condition which may or may not be true in certain applications.

Additionally, the above-discussed scheme cannot balance the load to processors of different sizes (i.e., processing power). Accordingly, large processors will be under-utilized and smaller processors will be over-utilized.

Still further, the above-discussed scheme includes low priority processes in the utilization calculation. In some instances, low priority processes can be deferred, and it may be preferable in some instances not to include such low priority processes in the utilization calculation. Without the ability to defer low priority processes, the load distribution may be inefficiently handled for certain situations.

Furthermore, the above-discussed scheme cannot assign a fixed number of bundles per processor. For certain processors, such as administrative processors, it is sometimes preferable to fix the number of bundles received by such processors irrespective of the low experience by the system and/or other processors in the multiprocessor system. Additionally, the above-discussed scheme is not a true load balancing approach in that it increases or decreases the number of bundles sent to the processor that exceeds or falls below a certain threshold instead of spreading the load to other processors.

### SUMMARY OF INVENTION

The invention relates, in an embodiment, to a method for redistributing workload among a plurality of processors in a computer system, whereby each processor of the plurality of processors is associated with a load value that indicates a level of workload assigned to the each processor. The method includes determining an average utilization level for the plurality of processors. The method further includes incrementing in a first scenario, if a utilization level of one of the processors is above the average utilization level by more than a predefined threshold, the load value assigned to each of the plurality of processors, except processors whose utilization level is above the average utilization level by more than the predefined threshold and whose immediately preceding adjustment to its load value in a previous adjustment cycle was an increment.

In another embodiment, the invention relates to an article of manufacture comprising a program storage medium having computer readable code embodied therein. The computer readable code is configured for redistributing workload among a plurality of processors in a computer system, whereby each processor of the plurality of processors being associated with a load value that indicates a level of workload assigned to the each processor. There is included computer readable code for determining an average utilization level for the plurality of processors. There is further included computer readable code for incrementing in a first scenario, if a utilization level of one of the processors exceeds the average utilization level by more than a predefined threshold, the load value assigned to each of the plurality of processors, except processors whose utilization level exceeds the average utilization level by more than the predefined threshold and whose immediately preceding adjustment to its load value in a previous adjustment cycle was an increment.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an example of a multi-processor system to facilitate discussion of the workload distribution issue.

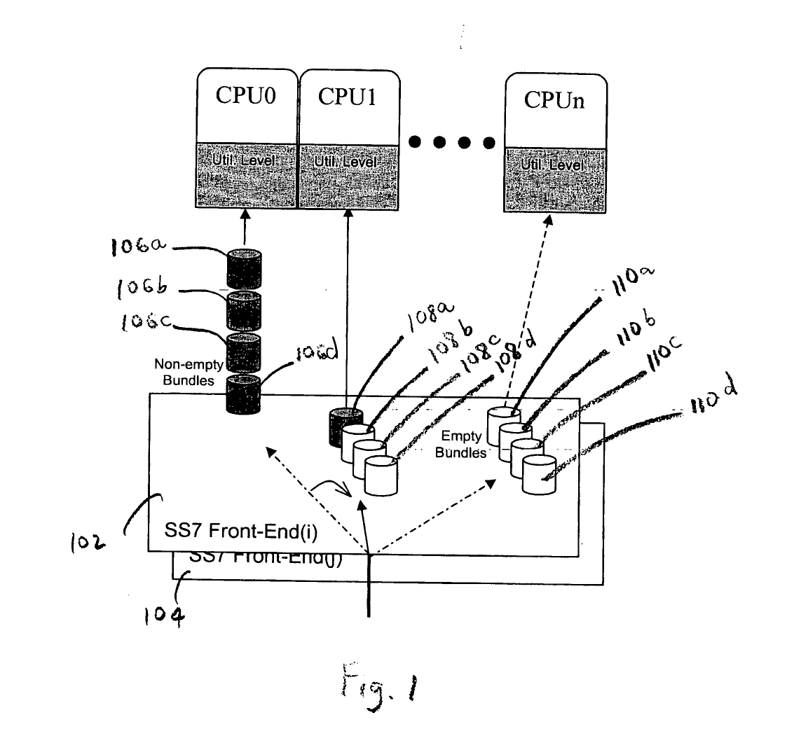

FIG. 2 shows a CPU of the multi-processor system having a higher than normal load, requiring workload redistribution.

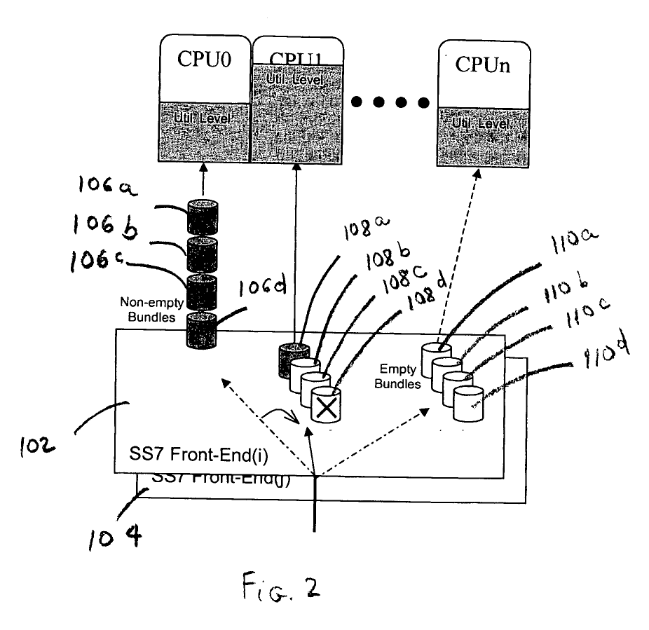

FIG. 3 illustrates the steps taken, in accordance with an embodiment of the present invention, during each sampling period to perform workload redistribution.

FIG. 4 illustrates, in an embodiment, the steps for ascertaining the applicable adjustment scenario.

FIG. 5 illustrates, in accordance with an embodiment of the present invention, the steps for adjusting the bundle values of the processors.

### DETAILED DESCRIPTION OF VARIOUS EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In accordance with an embodiment of the present invention, there is provided a dynamic load balancing technique which maintains a balanced load to each processor based on their utilization irrespective of the traffic load and the size of the processor in the system. The inventive dynamic load balancing technique is capable of maintaining the percentage utilization of each processor to within a narrow percentage range, e.g., two percent (e.g., 2% in one example). No assumption is made about the processing required for each message, i.e., each message can be unique in its processing requirement without adversely impacting the ability of the dynamic load balancing technique to evenly distribute the work among the processors.

With the inventive dynamic load balancing technique, processors of different sizes (processing power) can be mixed in the system since the adjustments are based on percentage of utilization in each processor. Furthermore, adjustments are made in incremental steps so that spikes in traffic are smoothed out and are made independent of the traffic load so that each processor utilization is approximately the same at all times.

If desired, low priority processes can be excluded from the utilization calculation so that only processes that need to be timely handled will be taken into account. Additionally, certain processors may have the number of bundles assigned to them fixed, e.g., to enable those processors to handle administrative tasks in an unimpeded manner irrespective of the traffic load experienced by the system as a whole.

In an embodiment, each processor is initially assigned a bundle value, i.e., the number of bundles to be received by that processor during each rotation of the round-robin distribution. The percentage utilization of the processors is then ascertained periodically. The percentage utilization data is then employed to calculate the needed adjustments of the assigned bundle values to the processors. During each sampling period, the percentage utilization for all processors in the multiple processor system is ascertained. If desired, low priority processes may be excluded from the calculation of the percentage utilization of the processors. For example, the user may set a threshold value for excluding processes whose priority values (as assigned by the system) are lower than this threshold value from the percentage utilization calculation.

An average utilization percentage is then calculated for the set of processors to be load-balanced. This set of processors to be load-balanced may be fewer in number than the total number of processors in the multiprocessor system since certain processors may be assigned with static, i.e., fixed, bundle values and they, therefore, do not need to be included in load balancing.

Furthermore, a utilization difference indicator is computed for the defined set of processors. This utilization difference indicator represents how evenly the processors are being utilized based on their utilization percentages. For example, a standard deviation value for the utilization percentages may be computed for the set of processors to be load-balanced. However, any other statistical measures can also be used to reflect the difference in utilization percentages among the processors.

If the utilization difference indicator indicates that all processors in the set of processors to be load-balanced are fairly close in their utilization percentages, no adjustment in the bundle values is needed for this sampling period.

On the other hand, if the utilization difference indicator indicates that at least one or more processors are being utilized to a higher or lower degree than a given threshold (e.g., a standard deviation or configured percentage), the adjustment algorithm computes the adjustments to be made in the bundle values assigned to the processors of the set of processors to be load-balanced.

In an embodiment, the standard deviation value is employed and if the standard deviation is less than or equal to two, no adjustments are made for the current sampling period. On the other hand, if the standard deviation is greater than two, the algorithm first determines the proposed adjustment for each processor. For each processor with the utilization percentage lower than the average utilization percentage minus standard deviation (or delta), the proposed adjustment equals the bundle value assigned to that processor plus one.

In another embodiment, the system user can configure a utilization percentage that they want the processor utilization to be within. In this case, the percentage delta is used if the utilization difference is greater than 1 standard deviation. If the difference is within one standard deviation, no adjustment will be made even if the percentage difference is smaller than the utilization difference.

On the other hand, for each processor with a utilization percentage higher than the average utilization percentage plus standard deviation (or a percentage delta), the proposed adjustment equals the bundle value assigned to that processor decremented by one.

Thereafter, the proposed adjustment is compared with the previous adjustment, i.e., the adjustment in the previous cycle for each CPU in the set of CPUs to be load-balanced.

The comparison determines the actual adjustment to be made. There are three possible adjustments to be made, depending on the scenarios ascertained by the comparison. In the order of decreasing priority, they are: increase-decrease, decrease-increase, and neither. If the proposed adjustment for any processor is a decrease when the previous adjustment was an increase (thus, the terminology “increase-decrease”), then for these specific processors, the adjustment shall be no change (zero) and the adjustments for all other processors in the set of processors to be load-balanced will be an increase of plus one bundle. This causes an indirect decrease in the load presented these aforementioned specific processors.

If an increase-decrease condition was not found, and if a proposed adjustment for a CPU is an increase when the previous adjustment was a decrease (thus, the terminology “decrease-increase”), then the adjustment for all processors in the set of processors to be load-balanced will be an increase of plus one bundle. This causes an indirect increase to the specific processor. This action and the previous action (for the increase-decrease case) are included to prevent the method from “oscillating” the bundle sizes, and the offered load, to a specific processor from sample period to sample period. The unique adjustments made in these 2 cases also prevent the “run-away train” scenario from happening.

On the other hand, if neither of the increase-decrease nor decrease-increase conditions exist, then the proposed adjustment will apply.

In the special case that, if any bundle value for any processor falls below the minimum value, the bundle values for all processors are increased by one. The minimum bundle value may be pre-configured by the system user. For example, a typical minimum bundle value could be 2 or 3 bundles. Although this adjustment appears to be similar to the increase-decrease adjustment; the relative difference in bundles for each processor remains consistent with the adjustments that were accepted for the sample period since both period adjustments and the minimum value adjustments are applied during the period. Hence, the necessary adjustments to the traffic to the processors are still achieved.

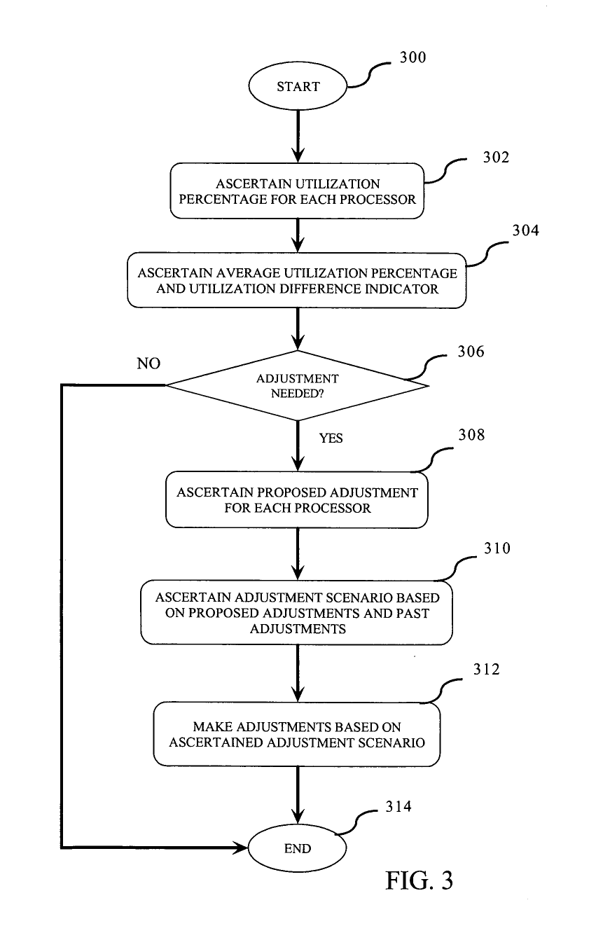

The inventive dynamic load balancing technique is illustrated, in accordance with an embodiment of the present invention, in FIG. 3. FIG. 3 illustrates the steps taken during each sampling period, which may be periodic or at random intervals. In step 302, the utilization percentage for each processor is ascertained. The utilization percentage represents, in an embodiment, the percentage of the processor's resource being utilized in the time period between the last sampling and the current sampling.

In step 304, the average utilization percentage for the processors in the set of processors to be load-balanced is ascertained. Furthermore, the utilization difference indicator is also ascertained in step 304. As mentioned, the standard deviation value may be employed as a utilization difference indicator.

In step 306, it is ascertained whether adjustment is needed based on the utilization difference indicator calculated in step 304. If one or more processors in the set of processors to be load-balanced has a higher or lower utilization percentage, either in absolute terms or relative to other processors in the set by a threshold amount, the adjustment algorithm is activated in steps 308, 310, and 312. In step 308, the proposed adjustment for each processor is ascertained. As mentioned, this proposed adjustment may represent an increment or decrement by one bundle, or no adjustment, to the bundle value assigned to the processors. The proposed adjustments are outlined in Table 1 below.

| | Proposed |
|---|---|
| | Individual CPU |
| Condition (per CPU) | Adjustment |
| Avg-CPU-Busy − S.D. < CPUi Busy < | No change |
| Avg-CPU-Busy + S.D. | |
| or | |
| Avg-CPU-Busy − Delta % < CPUi Busy < | |
| Avg-CPU-Busy + Delta % | |
| CPUi Busy ≦ Avg-CPU-Busy − S.D. | Increase |
| or | CPUi's value |
| CPUi Busy ≦ Avg-CPU-Busy − Delta % | by 1 |
| Avg-CPU-Busy + S.D. ≦ CPUi Busy | Decrease |
| or | CPUi's value |
| Avg-CPU-Busy + Delta % ≦ CPUi Busy | by 1 |

Avg-CPU-Busy represents the average utilization percentage; SD represents the standard deviation, CPUi Busy represents the utilization percentage of CPUi; Delta % or the difference in utilization percentages represents an example alternative measure of load imbalance (other than standard deviation).

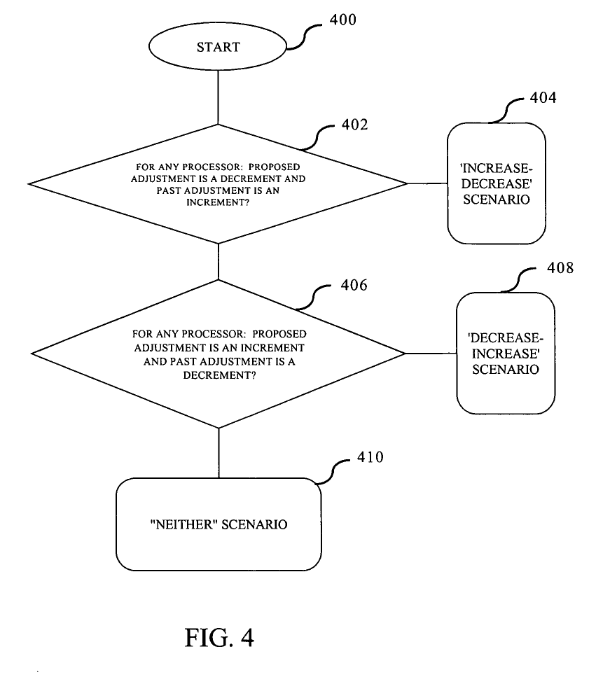

In step 310, the adjustment scenario based on the proposed adjustments and past adjustments for the processors is ascertained. FIG. 4 illustrates, in an embodiment, the steps for ascertaining the applicable adjustment scenario. As discussed, the adjustment scenarios, in the decreasing priority order, are: increase-decrease 404 (proposed adjustment is a decrease when the previous adjustment was an increase 402), decrease-increase 406 (proposed adjustment is an increase when the previous adjustment was a decrease 408), and neither 410.

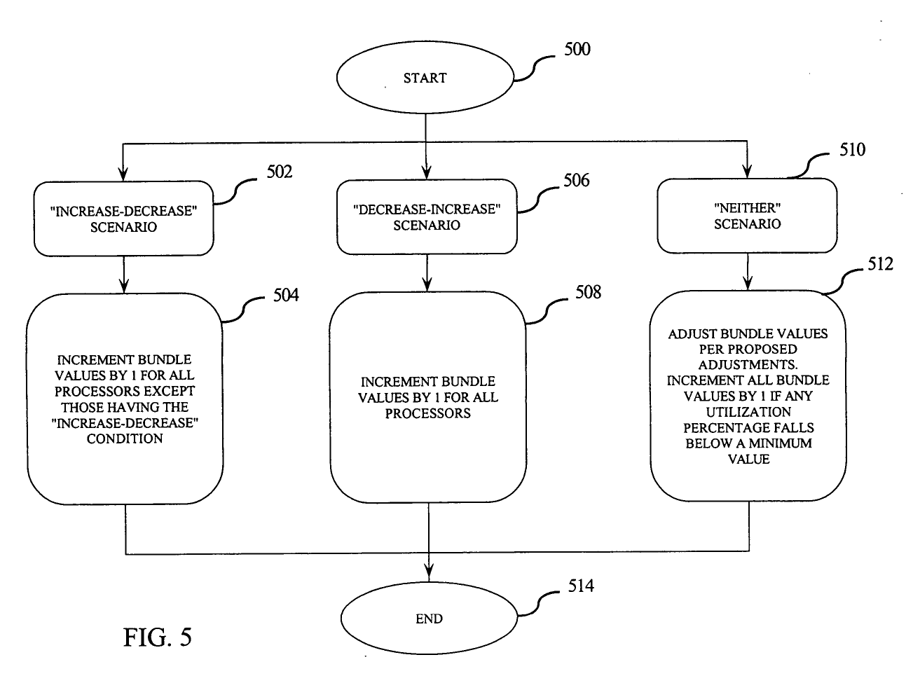

In step 312, the actual adjustments to the bundle values of the processors in the set of processors to be load-balanced are made. FIG. 5 illustrates, in accordance with an embodiment of the present invention, the steps for adjusting the bundle values of the processors. In the increase-decrease adjustment scenario 502, all processors, except those having the aforementioned increase-decrease condition, have their bundle values incremented by one (504). The specific processors associated with the increase-decrease condition themselves experience no change.

If the increase-decrease scenario is not found, but a decrease-increase scenario exists (506), all processors in the set of processors to be load-balanced have their bundle values incremented by one (508). If neither the increase-decrease nor the decrease-increase adjustment scenarios are found (i.e., the neither scenario 510 applies), the proposed adjustments calculated are applied (512). Furthermore, if the bundle value associated with any processor falls below a minimum value, the bundle values associated with all processors are increased by one (512).

It is important to note that the three scenarios occur in the alternative, i.e., only the adjustments under one of the scenarios will be applied. The increase-decrease adjustment scenario (502) has priority over the decrease-increase adjustment scenario (506), which in turn has priority over the “neither” adjustment scenario (510).

As can be appreciated from the foregoing, embodiments of the invention are capable of maintaining a balanced load to each processor based on their utilization irrespective of the traffic load and the size of the processor in the system. Adjustments can be made during each sampling period even in the absence of large imbalances, and the work can be evenly distributed even if different received messages have different processing requirements and/or different processors have different processing capabilities. By excluding certain processors from being load-balanced, certain processors can have the number of bundles assigned to them fixed.

Furthermore, embodiments of the invention can overlay (e.g., with algorithm) an existing front-end infrastructure that is already configured to increase or decrease the number of bundles distributed to one or more processors. Except for the implementation of the new algorithm, substantial changes in the hardware or software or firmware of the front-end are not required in an embodiment.

While this invention has been described in terms of several preferred embodiments, there are alterations, permutations, and equivalents which fall within the scope of this invention. For example, although the adjustment to the bundle values were performed by incrementing or decrementing by one bundle unit in the discussed examples, the adjustment may also employ any predefined adjustment value, including for example two bundle units or more. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

1. In a computer system, a method for redistributing workload among a plurality of processors, each processor of said plurality of processors being associated with a load value that indicates a level of workload assigned to said each processor, comprising:
determining an average utilization level for said plurality of processors; and
if a utilization level of one of said processors is above said average utilization level by more than a predefined threshold, incrementing, in a first scenario, said load value assigned to each of said plurality of processors, except processors whose utilization level is above said average utilization level by more than said predefined threshold and whose immediately preceding adjustment to its load value in a previous adjustment cycle was an increment.

2. The method of claim 1 wherein said incrementing in said first scenario is performed only if there exists a first processor among said plurality of processors whose utilization level, prior to said incrementing, is above said average utilization level by more than said predefined threshold and whose immediately preceding adjustment to a load value of said first processor in said previous adjustment cycle was an increment.

3. The method of claim 1 further comprising:
if, in a second scenario alternative to said first scenario, said utilization level of said one of said processors exceeds said average utilization level by more than said predefined threshold, incrementing said load value assigned to each of said plurality of processors if an immediately preceding adjustment to a load value of a processor in said plurality of processors was a decrement.

4. The method of claim 3 wherein said incrementing in said second scenario is performed only if there exists a first processor among said plurality of processors whose utilization level, prior to said incrementing, is above said average utilization level by more than said predefined threshold and whose immediately preceding adjustment to a load value of said first processor in said previous adjustment cycle was an increment.

5. The method of claim 3 further comprising:
adjusting, in a third scenario alternative to both said first scenario and said second scenario, load values associated with selected processors of said plurality of processors, said selected processors including a first group of processors whose utilization level exceeds said average utilization level by more than said predefined threshold and a second group of processors whose utilization level is below said average utilization level by more than said predefined threshold, said adjusting including decrementing load values associated with said first group processors and incrementing load values associated with said second group of processors.

6. The method of claim 1 further including:
incrementing said load value associated with said each of said plurality of processors if a bundle value of any of said plurality of processors is below a minimum bundle value.

7. The method of claim 1 wherein said incrementing is accomplished by adding a predefined value to said load value associated with said each of said plurality of processors.

8. The method of claim 7 wherein a determination of whether said utilization level of said one of said processors is above said average utilization level by more than said predefined threshold employs a standard deviation calculation.

9. The method of claim 8 wherein said determination of whether said utilization level of said one of said processors is above said average utilization level by more than said predefined threshold is performed without taking into account low priority processes, said low priority processes representing processes whose priority level is below a pre-defined priority level.

10. The method of claim 1 wherein said workload is divided into a plurality of bundles, said load level associated with said each processor of said plurality of processors is expressed in bundle units.

11. The method of claim 10 wherein said each of said plurality of processors is assigned an initial bundle value at system startup.

12. The method of claim 1 wherein said plurality of processors are fewer in number than a total number of processors executing processes in said computer system.

13. The method of claim 1 wherein said workload is redistributed periodically throughout an execution lifetime of a given process.

14. An article of manufacture comprising a program storage medium having computer readable code embodied therein, said computer readable code being configured for redistributing workload among a plurality of processors in a computer system, each processor of said plurality of processors being associated with a load value that indicates a level of workload assigned to said each processor, comprising:
computer readable code for determining an average utilization level for said plurality of processors; and
computer readable code for incrementing in a first scenario, if a utilization level of one of said processors exceeds said average utilization level by more than a predefined threshold, said load value assigned to each of said plurality of processors,
except processors whose utilization level exceeds said average utilization level by more than said predefined threshold and whose immediately preceding adjustment to its load value in a previous adjustment cycle was an increment.

15. The article of manufacture of claim 14 wherein said incrementing in said first scenario is performed only if there exists a first processor among said plurality of processors whose utilization level, prior to said incrementing, exceeds said average utilization level by more than said predefined threshold and whose immediately preceding adjustment to a load value of said first processor in said previous adjustment cycle was an increment.

16. The article of manufacture of claim 14 further comprising:
computer readable code for incrementing, in a second scenario alternative to said first scenario, if said utilization level of said one of said processors is below said average utilization level by more than said predefined threshold, said load value assigned to each of said plurality of processors if an immediately preceding adjustment to a load value of a processor in said plurality of processors was a decrement.

17. The article of manufacture of claim 16 further comprising:
computer readable code for adjusting, in a third scenario alternative to both said first scenario and said second scenario, load values associated with selected processors of said plurality of processors, said selected processors consisting of a first group of processors whose utilization level exceeds said average utilization level by more than said predefined threshold and a second group of processors whose utilization level is below said average utilization level by more than said predefined threshold, said adjusting including decrementing load values associated with said first group processors and incrementing load values associated with said second group of processors.

18. The article of manufacture of claim 14 further including:
computer readable code for incrementing said load value associated with said each of said plurality of processors if a bundle value of any of said plurality of processors is below a minimum bundle value.

19. The article of manufacture of claim 14 wherein said incrementing is accomplished by adding a predefined value to said load value associated with said each of said plurality of processors.

20. The article of manufacture of claim 19 wherein a determination of whether said utilization level of said one of said processors is above said average utilization level by more than said predefined threshold employs a standard deviation calculation.

21. The article of manufacture of claim 20 wherein said determination of whether said utilization level of said one of said processors is above said average utilization level by more than said predefined threshold is performed without taking into account low priority processes, said low priority processes representing processes whose priority level is below a pre-defined priority level.

22. The article of manufacture of claim 14 wherein said workload is divided into a plurality of bundles, said load level associated with said each processor of said plurality of processors is expressed in bundle units.

23. The article of manufacture of claim 22 wherein said each of said plurality of processors is assigned an initial bundle value at system startup.

24. The article of manufacture of claim 14 wherein said plurality of processors are fewer in number than a total number of processors executing processes in said computer system.

25. The article of manufacture of claim 14 wherein said workload is redistributed periodically throughout an execution lifetime of a given process.
